(19) United States
(12) Patent Application Publication
(10) Pub. No.: US 2015/0187035 A1
(43) Pub. Date: Jul. 2, 2015

(54) SUPPLY MANAGEMENT IN A CLINICAL SETTING

(71) Applicant: CERNER INNOVATION, INC., KANSAS CITY, KS (US)

(72) Inventors: CASEY JAY HOGAN, Kansas City, MO (US); TIMOTHY JOHN SLEDDENS, Prairie Village, KS (US)

(73) Assignee: CERNER INNOVATION, INC., KANSAS CITY, KS (US)

(21) Appl. No.: 14/143,798

(22) Filed: Dec. 30, 2013

(51) Int. Cl. G06Q 50/22; G06Q 10/06

(52) U.S. Cl. CPC G06Q 50/22; G06Q 10/06315

(57) ABSTRACT

Aspects of the present invention provide a supply chain system to get to a just-in-time inventory. Aspects of the invention generate a suggested reorder quantity by comparing the item's reorder point (quantity at which to reorder the item from the vendor) to the dynamic inventory level for the item. The dynamic inventory level=(Quantity in inventory+Quantity on Order−(Forecast Usage)). The forecast usage comprises anticipated consumption of the item derived from one or more presently scheduled clinical events. Presently scheduled events have not yet taken place and are scheduled to take place in the future. The event takes place when a clinician provides a clinical service to a patient. For example, a surgery may be scheduled to occur three days from the present time. The items scheduled for use in the surgery form part of the forecast usage for the item. The forecast usage may comprise items from multiple scheduled clinical events.

### BACKGROUND

Hospitals and other clinical facilities manage the effective delivery of health services while containing the overall costs of their clinical operations. Administrators at a large hospital may have to track inventory, manage ordering, and coordinate billing for a vast array of medical supplies in the clinical environment. Supplies and material from surgical tools, implants, electronic monitoring or diagnostic equipment, gowns, gloves, pharmaceuticals, disposable material such as tissues, bandages, and a host of other supplies must be monitored, stored, and requisitioned in a timely manner to ensure the smooth operation of surgical, radiological, emergency and other departments and facilities.

Collective supply activities are not effectively or comprehensively managed on today's information platforms. While many hospitals and other facilities keep computerized records of clinical supplies present and available in given departments, no effective or integrated mechanism exists to order and replenish those supplies on demand. Even when database tools permit managers a quantitative view of remaining inventory or available supplies, requisitioning those supplies is still often left to a manual ordering and fulfillment process. Certain existing platforms do not leverage the possibility of establishing a supply chain network in which supply orders may be automatically generated based on scheduled clinical events and the effect of these events on inventory states, or automatically fulfilled via a vendor communications channel and electronic billing arrangement. Other problems in current clinical supply platforms and practices exist.

### SUMMARY

Aspects of the invention are defined by the claims below, not this Summary. A high-level overview of various aspects of the invention are provided here for that reason, to provide an overview of the disclosure, and to introduce a selection of concepts that are further described below in the Detailed Description. This Summary is not intended to identify key features or essential features of the claimed subject matter, nor is it intended to be used as an aid in isolation to determine the scope of the claimed subject matter.

Aspects of the present invention provide a supply chain system to get to a just-in-time inventory. Aspects of the invention generate a suggested reorder quantity by comparing the item's reorder point (quantity at which to reorder the item from the vendor) to the dynamic inventory level for the item. The dynamic inventory level=(Quantity in inventory+Quantity on Order−(Forecast Usage)). The forecast usage comprises anticipated consumption of the item derived from one or more presently scheduled clinical events. Presently scheduled events have not yet taken place and are scheduled to take place in the future. The event takes place when a clinician provides a clinical service to a patient. For example, a surgery may be scheduled to occur three days from the present time. The items scheduled for use in the surgery form part of the forecast usage for the item. The forecast usage may comprise items from multiple scheduled clinical events.

### BRIEF DESCRIPTION OF THE SEVERAL VIEWS OF THE DRAWINGS

Illustrative aspects of the present invention are described in detail below with reference to the attached drawing figures, wherein:

FIG. 1 is a block diagram depicting an exemplary computing environment suitable for use in implementing aspects of the present invention;

FIG. 2 is a block diagram depicting an exemplary computing architecture suitable for supply chain management, in accordance with an aspect of the present invention;

FIG. 3 is a diagram showing an order interface, in accordance with an aspect of the present invention;

FIG. 4 is a diagram showing an order interface, in accordance with an aspect of the present invention;

FIG. 5 is a flow diagram showing a method of automatically generating orders for clinically related supplies, in accordance with an aspect of the present invention; and

FIG. 6 is a flow diagram showing a method of managing inventory for clinically related supplies, in accordance with an aspect of the present invention.

### DETAILED DESCRIPTION

Having briefly described aspects of the present invention, an exemplary operating environment suitable for use in implementing aspects of the present invention is described below. Some of the wording and form of description is done to meet applicable statutory requirements. Although the terms “step” and/or “block” or “module,” etc. might be used herein to connote different components of methods or systems employed, the terms should not be interpreted as implying any particular order among or between various steps herein disclosed unless and except when the order of individual steps is explicitly described.

Aspects of the present invention provide a supply chain system to get to a just-in-time inventory. Just-in-time ordering reduces the overhead within a clinical setting by reducing the quantity of supplies in the clinical setting's inventory. Aspects of the invention generate a suggested reorder quantity by comparing the item's reorder point (quantity at which to reorder the item from the vendor) to the dynamic inventory level for the item. The dynamic inventory level=(Quantity in inventory+Quantity on Order−(Forecast Usage)). In one aspect, the quantity on order is defined as the quantity on order that is scheduled to arrive during a forecasting period, for example, the next three days.

The forecast usage is for a period of time, for example, the next three days. Different items may have a different period of time. In one aspect, the period of time used to evaluate an item is based on an anticipated delivery time for the item. It may be generally desirable to use a longer forecast time for items with longer delivery times. The anticipated delivery time may be the average or the maximum delivery time. The average or maximum delivery could be determined by tracking actual delivery times for previous orders. Alternatively, the delivery time could be provided by a vendor. The time used to generate a forecast usage may be the expected delivery time for an item extended by a safety threshold.

The forecast usage comprises anticipated consumption of the item derived from one or more presently scheduled clinical events. Scheduled clinical events have not yet taken place and are scheduled to take place in the future. Events that have already taken place are not considered scheduled events for the purpose of this disclosure. The event takes place when a clinician provides the clinical service associated with the event to a patient. For example, a surgery may be scheduled to occur two days from today. The items scheduled for use in the surgery can form part of a forecast usage. The forecast usage may comprise items from multiple scheduled clinical events.

The scheduled event may be associated with a clinician, patient, facility, and procedure details, and a picklist. The picklist describes a quantity of each item that needs to be present when the clinical event takes place. The picklist can be divided into open and hold items. The hold items may be returned to inventory if not used during the clinical event. The open items will be opened and ready for use during the clinical event and will not be returned to inventory. Hold items and open items may be treated differently when calculating a forecasted usage.

In one aspect, a raw forecast usage is calculated. The raw forecast usage for a time period can be calculated by determining the total quantity of items scheduled to be used in scheduled clinical events within the time period. In another aspect, an adjusted forecast usage is calculated by adjusting the raw forecast usage by a confidence factor. The confidence factor may describe a probability that the scheduled clinical event actually occurs. For example, the confidence factor may be derived from an analysis of how often different types of clinical events are canceled. Different events may have different confidence factors. Further, different factors, such as clinicians involved may impact confidence factors. The confidence factor may take into consideration more than just the type of clinical event. The patient's electronic medical record may be evaluated to optimize the confidence factor for patients having similar characteristics. The characteristics may be clinical. Other characteristics, such as insurance status, credit rating, or similar may be used to calculate a confidence factor.

Having provided an overview of the invention, aspects of the invention are described in more detail below.

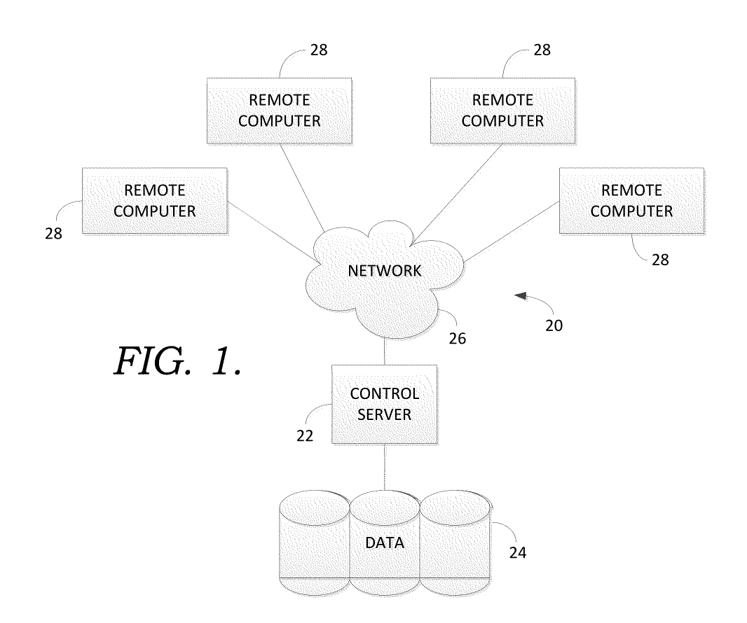

Referring to the drawings in general, and initially to FIG. 1 in particular, an exemplary computing system environment, for instance, a medical information computing system, on which aspects of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, smartphones, tablets, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer-storage media including, by way of example only, memory storage devices.

With continued reference to FIG. 1, the exemplary medical information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus.

The control server 22 typically includes therein, or has access to, a variety of computer-readable media, for instance, database cluster 24. Computer-readable media can be any available media that may be accessed by control server 22, and includes volatile and nonvolatile media, as well as removable and non-removable media. By way of example, and not limitation, computer-readable media may include computer-storage media and communication media.

Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium that can be used to store the desired information and that may be accessed by the control server 22. The computer-storage media does not comprise non-transitory forms of media.

Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer-storage media discussed above and illustrated in FIG. 1, including database cluster 24, provide storage of computer readable instructions, data structures, program modules, and other data for the control server 22.

The control server 22 may operate in a computer network 26 using logical connections to one or more remote computers 28. Remote computers 28 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home healthcare environments, and clinicians' offices and the clinician's home or the patient's own home or over the Internet. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 28 may also be physically located in non-traditional medical care environments so that the entire healthcare community may be capable of integration on the network. The remote computers 28 may be personal computers, servers, routers, network PCs, peer devices, other common network nodes, or the like, and may include some or all of the elements described above in relation to the control server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., control server 22 and remote computers 28) may be utilized.

In operation, a user may enter commands and information into the control server 22 or convey the commands and information to the control server 22 via one or more of the remote computers 28 through input devices, such as a keyboard, a pointing device (commonly referred to as a mouse), a trackball, touchscreen, microphone, or a touch pad. Other input devices may include, without limitation, satellite dishes, scanners, or the like. Commands and information may also be sent directly from a remote healthcare device to the control server 22. In addition to a monitor, the control server 22 and/or remote computers 28 may include other peripheral output devices, such as speakers and a printer.

Many other internal components of the control server 22 and the remote computers 28 are not shown because such components and their interconnection are well known. Accordingly, additional details concerning the internal construction of the control server 22 and the remote computers 28 are not further disclosed herein.

Although methods and systems of aspects of the present invention are described as being implemented in a WINDOWS or LINUX operating system, operating in conjunction with an Internet-based delivery system, one of ordinary skill in the art will recognize that the described methods and systems can be implemented in any system supporting the search of electronic medical records. As contemplated by the language above, the methods and systems of aspects of the present invention may also be implemented on a stand-alone desktop, personal computer, cellular phone, smartphone, PDA, or any other computing device used in a healthcare environment or any of a number of other locations.

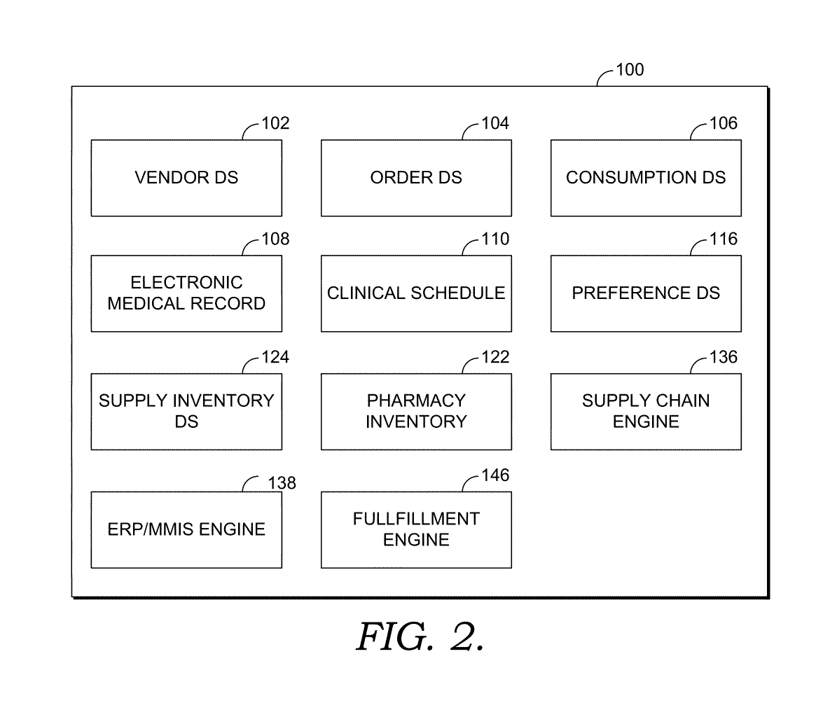

FIG. 2 illustrates a supply management system 100 in which a system and method for management of clinical supply operations may operate, according to an aspect of the invention. The supply management system 100 is merely an example of one suitable computing system environment and is not intended to suggest any limitation as to the scope of use or functionality of embodiments of the present invention. Neither should the supply management system 100 be interpreted as having any dependency or requirement related to any single module/service/component or combination of modules/services/components illustrated therein.

At a high level, the supply chain engine 136 can calculate a forecast usage by analyzing scheduled clinical events described within the clinical schedule component 110. The schedule component 110 may provide interfaces through which clinical events are scheduled and/or store data describing clinical events scheduled within a clinical site. Upon detecting that the anticipated usage of the supply exceeds the anticipated supply level, the supply chain engine 136 may automatically trigger orders for the supply. Alternatively, the supply chain engine 136 may provide an interface through which order confirmations are received from a clinician or support staff. The interface may provide alerts that point out clinical items having an anticipated supply shortage. The supply chain engine 136 may use the fulfillment engine 146 and the ERP/MMIS engine 138 to interface with vendors and secure the delivery of ordered clinical items.

The supply chain engine 136 may draw on clinical supply data and clinical event data stored in various existing databases found within a clinical setting. Different metrics describing clinical operation may be collected and stored to various data stores. The clinical data may include, for example, vendor or manufacturer data stored to a vendor database 102, purchase or transaction data for supplies and materials stored to a purchase database 104, and data regarding supplies, which are picked or used from available supply, which is stored to consumption database 106. The consumption database 106 may be used for patient billing and analysis of supply usage. Other data types and data stores will be described subsequently.

The clinical supplies tracked and managed by aspects of the invention can include any surgical, medical, diagnostic or other instruments, equipment, pharmaceutical or other clinically related disposable or non-disposable items, such as, for example, surgical instruments such as scalpels, forceps, catheters, laparoscopes, joint, bone, dental or other implants, intravenous lines, saline solution, blood serum, syringes, laboratory supplies such as fluid sample cartridges, assay solution or other material, diagnostic material such as X-ray film, pharmaceuticals such as antibiotics or analgesics or other prescription or non-prescription medications or treatments, protective clothing such as gowns, masks or others or any other clinically related material. The actual usage may be stored in consumption data store 106 and analyzed. A hospital or other administrator can view the “run” or consumption rate for supplies of surgical instruments or blood serum orders, or calculate the total cost of splints, bandages or other disposable or other material at that clinical site using various analytic tools that use the consumption data.

The clinical documentation for the clinical event captures the clinical supplies, which are actually used or consumed during the clinical event. The consumption data may be recorded to consumption database 106, to indicate whether clinical items were used or unused and returned to inventory after a clinical event. According to aspects of the invention, analytic views on supply selection, consumption, and cost may be extended to the individual patient level, or lowered to single encounters or other micro clinical details. According to aspects of the invention as shown, supply details of clinical treatment and encounters at the level of an individual patient may be recorded and tracked in a patient supply record, which comprehensively traces consumed supplies and material to individual patients during the course of their entire medical care.

The selection and consumption of clinical supplies at a hospital or other clinically related site may be guided by the supply selections of physicians and other care providers. More specifically, each care provider may select preferred surgical instruments, anesthesiology drugs, equipment, implants, pharmaceuticals, stethoscope, thermometer or other diagnostic instruments or other supplies, material, pharmaceuticals or other hardware, disposables or other material related to clinical care. In aspects, each physician or other care provider may select preferred supply choices on a physical or electronic preference card whose selections are recorded in a preference database 116. The preferred supplies may be automatically retrieved by the supply chain engine 136 using data associated with a scheduled clinical event.

When a clinical event such as a consultation, evaluation, surgery, X-ray imaging or other patient encounter or instance of treatment is scheduled, the preference database 116 may be accessed to determine the preferred clinical items for the given type of procedure for the one or more care providers attending the patient. The supplies associated with the scheduled clinical event can be used to forecast usage of each clinical item.

More specifically, when an individual patient is scheduled for a clinical event, the preference card for attending physicians or other care providers may be consulted to make appropriate surgical, pharmaceutical, diagnostic or other supplies available for the given procedure or treatment in view of the patient's characteristics. The clinical items scheduled for use on the individual patient form part of the forecast usage. Thus, the forecast usage can be based on a combination of clinician preferences and the actual patient associated with the scheduled event. The actual supplies used to treat a specific patient can vary from patient to patient even when the procedure is performed by the same clinician. Factors such as a patient's age, size, gender, and allergies can cause different supplies to be appropriate for the scheduled clinical event.

During the occurrence of the clinical event, the physicians or other care providers may make on-the-spot selections from the clinically available supplies and use that picked supply to deliver care. During or after the clinical event, the picked supply and other data may be stored in a verified consumed supply record, which records items and quantities of supplies consumed during the clinical event. In aspects, the verified consumed supply record may likewise link to a pharmacy database 122 to record pharmaceuticals prescribed or administered, if appropriate. Patient supply records may also link to an electronic medical record (EMR) database 126, to access and store clinical information related to the patient's medical condition and care.

Prior to occurrence of a scheduled clinical event, a provider may consult or create a procedure card, for instance detailing necessary supplies for a standard carpal tunnel procedure. The physician or other care provider may then derive a patient-specific procedure card to encapsulate necessary clinical supplies for that particular patient and their scheduled procedure, for instance taking into account the patient's age, physical condition, allergies or other factors. Upon receipt of the updated clinical supply data, the supply chain engine may generate a forecast usage for items involved in the procedure. The forecast usage may also draw on other scheduled clinical events where use of the clinical items is scheduled.

In one aspect, a clinician is given an opportunity to finalize the supply selection for a scheduled clinical event. Within a forecast usage, finalized supply selections and tentative supply selections may be assigned a different level of confidence to arrive at a final forecast usage. A confidence factor describes a probability that an individual clinical item will actually be used or consumed in the future. For example, a finalized selection of the supply may result in a confidence factor of 0.95 (or 95%). The confidence factor associated with the same item scheduled for use in a non-finalized supply selection may be given a 0.75 confidence factor. Different confidence factors may be assigned to different types of clinical items scheduled for use in the same clinical event. For example, items associated with common allergies may be assigned a lower confidence factor than a clinical item with a rare need for substitution because the item associated with a common allergy is more likely to be substituted with another item.

The confidence factor may describe a probability that the scheduled clinical event actually occurs. For example, the confidence factor may be derived from an analysis of how often different types of clinical events are canceled. Different events may have different confidence factors. Further, different factors, such as clinicians involved may impact confidence factors. The confidence factor may take into consideration more than just the type of clinical event. The patient's electronic medical record may be evaluated to optimize the confidence factor for patients having similar characteristics. The characteristics may be clinical. Other characteristics, such as insurance status, credit rating, or similar may be used to calculate a confidence factor.

In one aspect, a machine learning algorithm is used to generate confidence factors for particular items. The machine learning algorithm may analyze previous consumption data and scheduling data and assign a confidence based on previous usage data. In some aspects, confidence factor is used to adjust the forecast usage.

Once the supplies are used or consumed, the inventory is updated. In the illustrative scenario, patients may receive clinical care during a clinical event, such as a surgical or dental procedure, during which physicians or other care providers may issue or select pick tickets or other indicators of desired supplies and material for the clinical service they are performing. As shown, the pick ticket or other selection indicator may be conveyed to or fulfilled by clinical supplies housed for instance in a case cart, such as a surgical instrument tray or cart. The supplies arrayed in case cart may be provided from a tracked inventory cart, which for instance, is stocked with tracked supply inventory, such as supplies and material encoded via bar code scan, RFID, manual entry or other techniques. The actual consumption of physical supplies may therefore in aspects be tracked while the clinical event is carried out, in real time or substantially real time, or in later administrative processing. The consumption may be documented on the preference card or by other clinical documentation known to those of skill in the art.

In aspects as shown, a tracked inventory cart may likewise communicate a state of clinical supply inventory to a supply chain engine 136, for instance to report quantities, condition, freshness or other data about instruments, diagnostic equipment, medications or other disposable or non-disposable supplies to that engine. Supply chain engine 136 may be configured, for instance, with a set of rules for evaluating the condition and status of the clinically available supplies reported in that fashion. Supply chain engine 136 may, for example, be programmed to detect the forecast quantity of a given supply reaching a certain threshold, upon which actions to resupply the clinical store may be automatically taken.

Specifically, supply chain engine 136 may generate an automatic supply request when a low reserve quantity of a given supply or other triggering criteria are reached. The automatic supply request may be communicated to other information resources in the organization, as illustrated to an enterprise resource planning/medical management information system (ERP/MMIS) engine 138. The ERP/MMIS engine 138 may process the automatic supply request, for instance to communicate a supply purchase order or other procurement document, file or transmission to a vendor, manufacturer or other supplier of clinical materials. In aspects, supply chain engine 136 may, depending on programmed rules, accumulate orders before generating automatic supply request for given types or categories of supplies to satisfy in batch or aggregate fashion, for instance to derive favorable purchase price or other terms, or when the order is for non-critical or non-time sensitive material.

A supply chain engine 136 can operate in or in conjunction with a clinically related site and may communicate an automatic supply request to an internal or external ERP/MMIS engine 138, which in turn transmits a supply order to a fulfillment engine 146, which may be located at or communicate with a supply vendor, such as a manufacturer or distributor of clinical supplies. The vendor, distributor or other entity may execute an automated purchase fulfillment of the supplies ordered in supply order, for example to direct that supplies be shipped or transported from a closest or most efficient warehouse or other supply facility to the ordering facility. Accounts receivable or other billing, tracking and other information may likewise be automatically exchanged or reconciled using business-to-business billing or other platforms. Purchase history data may likewise be returned to track cost, clinical and other variables, according to aspects of the invention.

In addition to generating an order, the supply chain engine 136 can provide forecast usage data to vendors to help the vendors manage their manufacturing process to help make sure supplies are available when an order for the supplies is issued. In one aspect, the forecast usage provided to manufactures is generated based on a window extending further into the future than a window used to generate orders or evaluate the possible need to issue orders for new items.

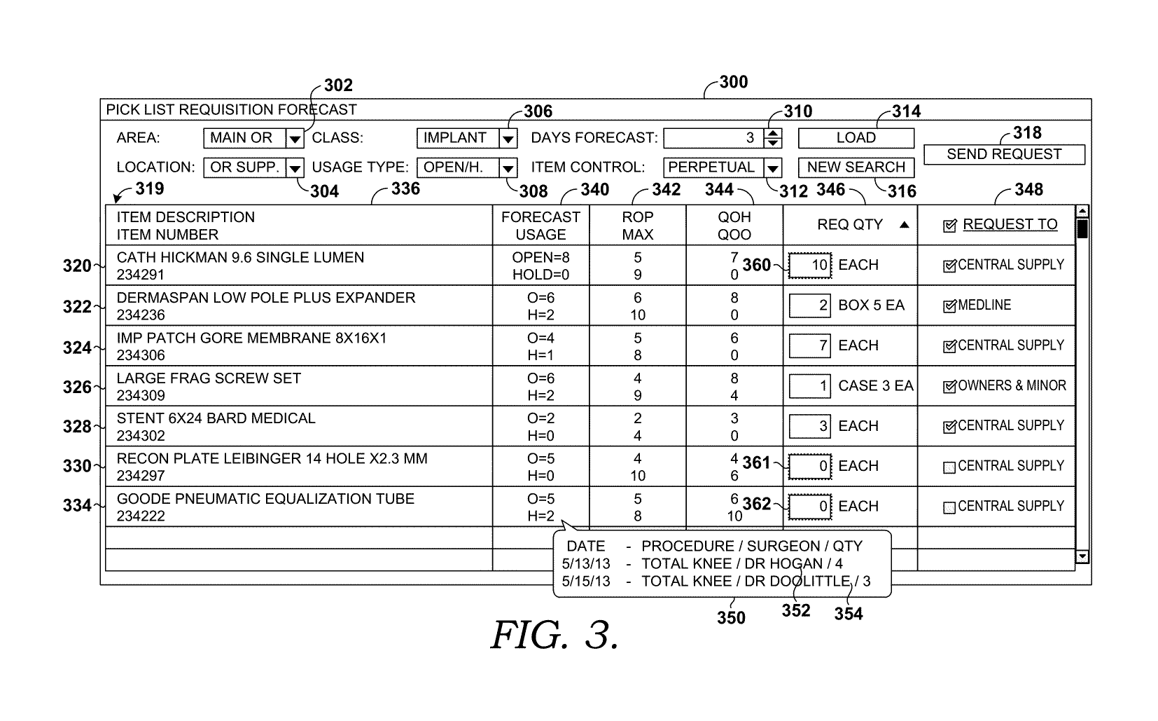

Turning now to FIG. 3, a dynamic inventory interface 300 is provided. The dynamic inventory interface 300 allows the user to set several parameters or filters that help define what information is shown. For example, an area within a clinical setting may be selected through area filter 302. In this case, the main operating room is selected. A clinical setting may have areas broken down by the type of treatment given. For example, a hospital may have an emergency room, maternity area, oncology area, orthopedics area, urology area, and other areas.

The location filter 304 designates a supply location within the clinical area. In this example, clinical items within the operating room supply location are shown. The class filter 306 can designate a type of clinical event. In this case, implant type clinical events are selected. The days forecast filter 310 allows a user to specify how many a days into the future to evaluate when calculating forecast usage. In this case, the forecast usage evaluates clinical events scheduled within the next three days from the present.

The item control filter 312 allows the user to specify whether or not the item is perpetual. The load button 314 causes clinical items that satisfy the filters to be shown in the item description area 319. The new search button 316 resets the filter criteria to default values and clears the items from the item description area 319. On resetting the filter values, a new set of items could be produced by pushing the load button 314. The send request button 318 causes an order request to be generated that is consistent with the checkboxes in the request column 348.

Various clinical items 320, 322, 324, 326, 328, 330, and 334, are shown in clinical item column 336. The description of each clinical item includes a title and an item number. The forecast usage column 340 shows the total forecast usage for each clinical item. As described previously, the forecast usage is the quantity of an item scheduled to be used in one or more scheduled clinical events. In this example, the scheduled clinical events are scheduled to occur within three days. The forecast usage may be broken down into a quantity of open and hold items. An open item is taken out of its package in preparation for the clinical event and is not returned to inventory. Hold items are removed from inventory and are on standby during the scheduled clinical event. If not used, then the hold items may be returned to inventory.

The reorder column 342 shows the reorder point (“ROP”) for each clinical item. For clinical item 320, the reorder point is five. The reorder column 342 also includes a maximum (“max”) inventory number for each clinical item. For clinical item 320, the maximum inventory number is nine.

The inventory column 344 shows the quantity on hand (“QOH”) and the quantity on order (“QOO”) for each clinical item. The quantity on hand for clinical item 320 is seven while the quantity on order for clinical item 320 is zero. In one aspect, the quantity on order is defined as the quantity of a clinical item that is on order and that is scheduled to arrive during the forecasting period, in this case, the next three days.

The reorder quantity column 346 shows the quantity of the clinical item suggested for reorder. For clinical item 320, the quantity box 360 shows that 10 items are recommended for order. The reorder level of 10 is arrived at by subtracting the forecast usage of eight from the quantity on hand of seven. This shows that the anticipated usage exceeds the current and anticipated supply by one. The anticipated supply includes quantity on order plus existing inventory, which is zero for clinical item 320. Ordering 10 of clinical item 320 will result in an inventory of nine after the scheduled clinical event is performed. Nine is the maximum number of item 320 that should be in inventory. Notice that items 322 and 326 must be ordered in bulk quantities for cases. The reorder column shows the number of cases needed to meet the anticipated demand given the present anticipated supply.

The reorder quantity for clinical item 330 and 334 is zero. In each case, the anticipated supply, including quantity on order, exceeds the anticipated usage by an amount greater than the reorder point. For example, the anticipated supply of clinical item 330 is 10 while the anticipated use is five. Thus, after the clinical event occurs, five of clinical item 330 should be left in inventory. Because five exceeds the reorder point of four no additional inventory is needed.

Interacting with the forecasted usage for a clinical item, such as by hovering over or clicking on the forecasted usage causes a details interface 350 to open. The details interface 350 provides details about the scheduled clinical event(s) in which the clinical items are to be used. In this case, scheduled clinical event 352 is a source of four of the seven forecasted uses of clinical item 334. Scheduled clinical event 354 is a source of three of the seven forecasted uses of clinical item 334.

An alarm can be provided when anticipated usage exceeds anticipated supply. An alarm can also be provided when the anticipated usage exceeds the quantity on hand. In this example, boxes 360, 361, and 362 include an annotation to draw the user's attention. The annotation may be highlighting, flashing, or some other visual indicia. For each of clinical item 322, 330, and 334 the forecast usage exceeds the quantity on hand. The visual indicia let the user know that additional attention or urgency may be required for these clinical items. The alarm indicating a shortage of clinical supplies may also be shown on a scheduling interface (not shown). An alarm can also take the form of a text, email, or other communication to one or more clinicians associated with a scheduled clinical event where a shortfall in supplies appears possible.

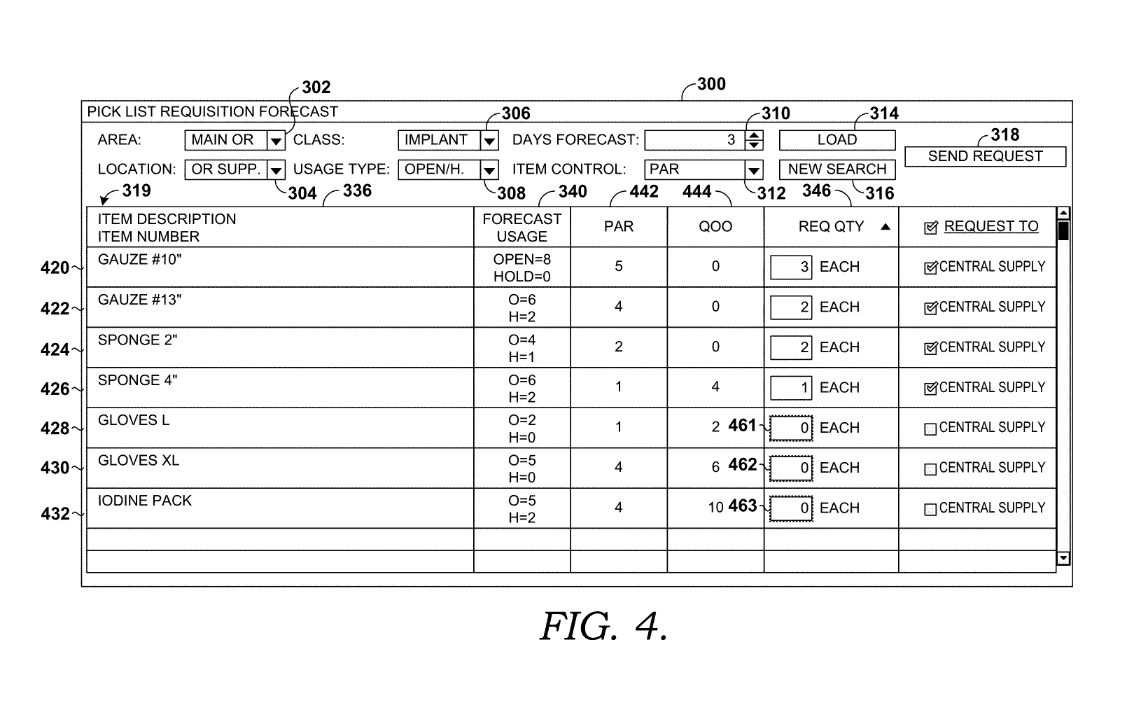

Turning now to FIG. 4, the dynamic supply interface 300 is shown filtered for PAR items. Notice that the filters are the same as in FIG. 3 except that the item control filter 312 has been selected to show PAR items.

Various clinical items 420, 422, 424, 426, 428, 430, and 432, are shown in clinical item column 336. The description of each clinical item includes a title, but not a serial number. In one aspect, PAR items are taken from inventory with attribution to a particular clinical event and are not individually tracked. Thus, a serial number for each PAR item may not be needed. The forecast usage column 340 describes the forecast usage for each clinical item. The PAR column 442 shows the reorder level. The quantity on order column 444 shows the quantity of a clinical item that has already been ordered. The reorder quantity column 346 shows the quantity of the clinical item suggested for reorder. For clinical item 420 the quantity box shows that 3 items are recommended for order. In this example, boxes 461, 462, and 463 included visual indicia to draw the user's attention. The annotation may be highlighting, flashing, or some other visual indicia. The annotation indicates clinical supplies that do not need to be reordered.

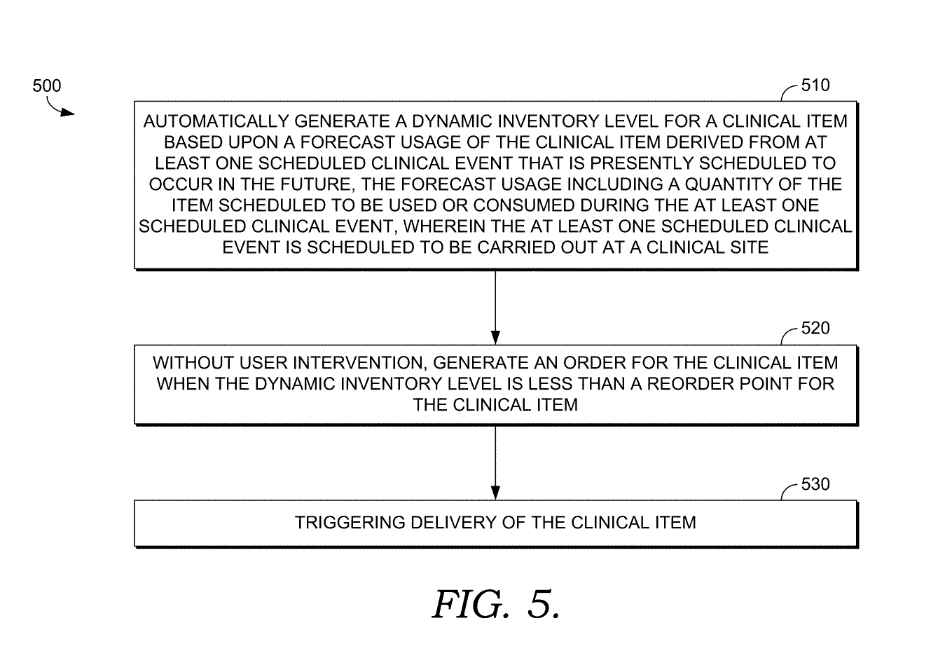

Turning now to FIG. 5, a method 500 of automatically generating orders for clinically related supplies is provided. Method 500 may be performed by a supply chain management system operating in association with one or more clinical sites. Exemplary clinical sites include hospitals, nursing homes, and government facilities. In one aspect, the supply chain management system manages supplies for a population management plan. For example, the supplies used to treat a population of diabetics across multiple facilities may be managed by a single supply management system. Management by other types of site or population characteristics is also possible.

At step 510 a dynamic inventory level is automatically generated for a clinical item based upon a forecast usage of the clinical item derived from at least one scheduled clinical event that is presently scheduled to occur in the future. The forecast usage includes a quantity of the item scheduled to be used or consumed during the at least one scheduled clinical event. The at least one scheduled clinical event is scheduled to be carried out at a clinical site.

At step 520, without user intervention, an order is generated for the clinical item when the dynamic inventory level is less than a reorder point for the clinical item. Specifically an automatic supply request may be generated when a threshold where anticipated usage exceeds anticipated supply or some other threshold from this point is reached. The automatic supply request may be communicated to other information resources in the organization, such as to an enterprise resource planning/medical management information system (ERP/MMIS) engine.

At step 530, delivery of the clinical item is triggered. The ERP/MMIS engine may process the automatic supply request, for instance to communicate a supply purchase order or other procurement document, file or transmission to a vendor, manufacturer or other supplier of clinical materials. In aspects, depending on programmed rules, orders may accumulate before triggering automatic supply request for given types or categories of supplies to satisfy in batch or aggregate fashion, for instance to derive favorable purchase price or other terms, or when the order is for non-critical or non-time-sensitive material.

The vendor, distributor or other entity may execute an automated purchase fulfillment of the supplies ordered in supply order, for example to direct that supplies be shipped or transported from a closest or most efficient warehouse or other supply facility to the ordering facility. Accounts receivable or other billing, tracking and other information may likewise be automatically exchanged or reconciled using business-to-business billing or other platforms. Purchase history data may likewise be returned to track cost, clinical and other variables, according to aspects of the invention.

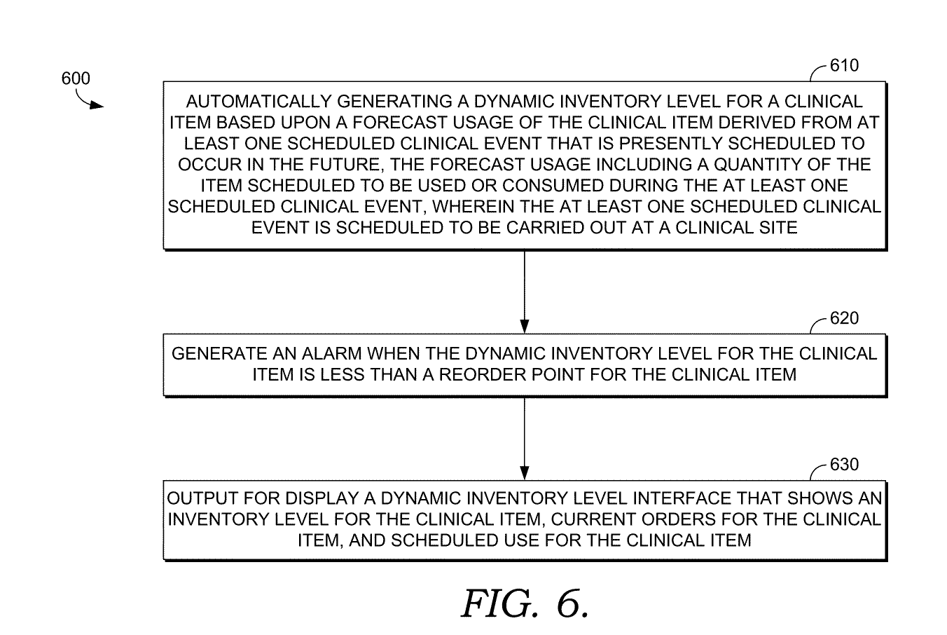

Turning now to FIG. 6, a method 600 for managing inventory for clinically related supplies is provided. Method 600 may be performed by a supply chain management system operating in association with one or more clinical sites. Exemplary clinical sites include hospitals, nursing homes, and government facilities.

At step 610, a dynamic inventory level is automatically generated for a clinical item based upon a forecast usage of the clinical item derived from at least one scheduled clinical event that is presently scheduled to occur in the future. The forecast usage includes a quantity of the item scheduled to be used or consumed during the at least one scheduled clinical event. The at least one scheduled clinical event is scheduled to be carried out at a clinical site.

At step 620, an alarm is generated when the dynamic inventory level for the clinical item is a negative number indicating that an anticipated use is greater than an anticipated supply. The alarm may take the form of an email or text to a clinician associated with a scheduled event or an administrator associated with the scheduled event. The alarm could take the form of a visual indicia or annotation on a supply or scheduling interface. In one aspect, the anticipated supply and forecast usage is compared after each new clinical event is scheduled. Upon detecting a forecast usage that exceeds anticipated supply, an alarm or notice may be provided as part of the event schedule. In one example, a calendar showing scheduled events will highlight clinical events where a supply shortage may impact the event if new supplies are not received before the clinical event takes place.

At step 630, a dynamic inventory interface is output for display that shows an inventory level for the clinical item, current orders for the clinical item, and scheduled use for the clinical item. In one aspect, the dynamic inventory interface may be similar to interface 300 or 400 described previously.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more non-transitory computer-storage media having computer-executable instructions embodied thereon for performing a method of automatically generating orders for clinically related supplies, the method comprising:
automatically generating a dynamic inventory level for a clinical item based upon a forecast usage of the clinical item derived from at least one scheduled clinical event that is presently scheduled to occur in the future, the forecast usage including a quantity of the item scheduled to be used or consumed during the at least one scheduled clinical event, wherein the at least one scheduled clinical event is scheduled to be carried out at a clinical site;
without user intervention, generating an order for the clinical item when the dynamic inventory level is less than a reorder point for the clinical item; and
triggering delivery of the clinical item.

2. The media according to claim 1, wherein the clinical site comprises at least one of a hospital facility, a research facility, out-patient medical facility, and a nursing home.

3. The media according to claim 1, wherein the clinical item is one of a surgical device, clinically available quantities of pharmaceuticals, and clinically available quantities of consumable medical material.

4. The media according to claim 1, wherein the dynamic inventory level for the clinical item comprises a quantity in inventory plus a quantity on order minus the forecast usage.

5. The media according to claim 1, wherein the at least one scheduled clinical event is associated with a patient, a clinical procedure, a picklist, and a clinician.

6. The media according to claim 5, wherein the picklist is specific to the clinical procedure and the patient.

7. The media according to claim 1, wherein the method further comprises using a cancelation factor to calculate the forecast usage, the cancelation factor being derived from historic cancelation data.

8. A method for managing inventory for clinically related supplies, comprising:
automatically generating a dynamic inventory level for a clinical item based upon a forecast usage of the clinical item derived from at least one scheduled clinical event that is presently scheduled to occur in the future, the forecast usage including a quantity of the item scheduled to be used or consumed during the at least one scheduled clinical event, wherein the at least one scheduled clinical event is scheduled to be carried out at a clinical site;
generating an alarm when the dynamic inventory level for the clinical item is a negative number indicating that an anticipated use is greater than an anticipated supply; and
outputting for display a dynamic inventory interface that shows an inventory level for the clinical item, current orders for the clinical item, and forecast use for the clinical item.

9. A method according to claim 8, wherein the clinical site comprises at least one of a hospital facility, a research facility, out-patient medical facility, a nursing home, and a government facility.

10. A method according to claim 8, wherein the dynamic inventory level is for a department within a clinical setting.

11. A method according to claim 8, wherein the dynamic inventory interface comprises an input that allows a user to specify how many days into the future on which to base the forecast usage.

12. A method according to claim 8, wherein the dynamic inventory interface shows the forecast usage for the clinical item including multiple clinical events in which the clinical item is scheduled to be used.

13. A method according to claim 8, wherein the forecast usage for the clinical item is divided into open and hold items, wherein the hold items are reserved for the at least one scheduled clinical event but may be returned to inventory when not used.

14. A method according to claim 8, wherein the alarm is generated in response to the at least one scheduled clinical event and communicated to a clinical scheduling the at least one scheduled clinical event.

15. A computerized system for managing clinical supplies, the system comprising:
a computing device associated with a supply management system having one or more processors and one or more computer-storage media; and
one or more data stores communicatively coupled to the supply management system, where in the supply management system:
receives scheduling data that describes one or more scheduled clinical events that are presently scheduled to occur in the future;
determines that a quantity of a clinical item is scheduled to be used or consumed during the one or more scheduled clinical event; and
updates a dynamic inventory level for the clinical item by subtracting the quantity scheduled to be used from a sum of a current inventory quantity and a quantity of the clinical item currently on order.

16. The system according to claim 15, wherein the supply management system further outputs for display an interface that shows the dynamic inventory level for the clinical item.

17. The system according to claim 15, wherein the supply management system further comprises an enterprise resource planning/medical management information system for automatically generating an order for the clinical item when the dynamic inventory level is less than a reorder point for the clinical item.

18. The system according to claim 15, wherein the order is for a reorder quantity that is generated by comparing the item's reorder point, which is a quantity at which to reorder the clinical item from a vendor, to the dynamic inventory level for the clinical item.

19. The system according to claim 15, wherein the quantity of a clinical item scheduled to be used or consumed during the one or more scheduled clinical events is determined by evaluating a picklist that is specific to a clinical procedure and a patient associated with the clinical event.

20. The system according to claim 15, wherein the clinical item is an implant.
